(19) United States
(12) Patent Application Publication
(10) Pub. No.: US 2010/0237755 A1
(43) Pub. Date: Sep. 23, 2010

(54) STORAGE AND ORGANIZATION SYSTEM AND CONNECTIVITY OF THE COMPONENTS THEREIN

(75) Inventor: Kevin ZALEWSKI, Rochester Hills, MI (US)

Correspondence Address: TARGET BRANDS, INC., 1000 NICOLLET MALL, TPS-3165, MINNEAPOLIS, MN, 55403, US

(73) Assignee: TARGET BRANDS, INC., MINNEAPOLIS, MN (US)

(21) Appl. No.: 12/554,034

(22) Filed: Sep. 4, 2009

Related U.S. Application Data
(60) Provisional application No. 61/160,977, filed on Mar. 17, 2009.
(60) Provisional application No. 61/161,019, filed on Mar. 17, 2009.

(51) Int. Cl. A47B 87/00; A47B 97/00; F16B 12/00

(52) U.S. Cl. 312/111; 312/352

(57) ABSTRACT

A storage shell includes a plurality of sidewalls to collectively define a chamber therebetween. A first sidewall defines a panel and a track. The panel defines an outer perimeter edge, an exterior surface, and holes extending through the panel. The track is coupled to the panel and includes a first rib and a second rib each extending from the exterior surface. The first rib is positioned inside the outer perimeter edge. The second rib is concentric with and shaped similarly to the first rib. The first rib and the second rib each separately border each one of the holes where each of the holes is formed between the first rib and the second rib. Related storage and organization systems, accessories and methods are also disclosed and provide additional advantages.

### CROSS-REFERENCE TO RELATED APPLICATIONS

The present application is a Non-Provisional Application of U.S. Provisional Application No. 61/160,977, entitled “STORAGE AND ORGANIZATION SYSTEM AND CONNECTIVITY OF THE COMPONENTS THEREIN,” filed on Mar. 17, 2009, which is related to pending U.S. Utility patent application Ser. No. 11/851,165, entitled “STORAGE AND ORGANIZATION SYSTEM AND COMPONENTS THEREOF,” filed Sep. 6, 2007; pending U.S. Design application No. 29/284,375, entitled “STORAGE BIN,” filed Sep. 6, 2007; pending U.S. Design application No. 29/284,379, entitled “LID PORTION,” filed Sep. 6, 2007; pending U.S. Design application No. 29/329,629, entitled “STORAGE BIN,” filed Dec. 18, 2008; pending U.S. Provisional Application No. 61/161,019, entitled “STORAGE AND ORGANIZATION SYSTEM WITH STACKABLE SHELLS,” filed on Mar. 17, 2009; pending U.S. Design application No. 29/333,915, entitled “STORAGE UNIT AND STORAGE UNIT PORTIONS,” filed on Mar. 17, 2009; pending U.S. Design application No. 29/333,916, entitled “DRAWER AND DOOR,” filed on Mar. 17, 2009; pending U.S. Design application No. 29/333,917, entitled “SUPPORTING BASE,” filed on Mar. 17, 2009; and pending U.S. Design application No. 29/333,918, entitled “TRAY,” filed on Mar. 17, 2009; all of which are incorporated herein by reference.

### BACKGROUND OF THE INVENTION

Many organization and storage items and systems are available to assist consumers in storing and organizing their belongings. However, in general, consumers continually accumulate items and/or transfer items from one location in a home to another. Accordingly, a storage and organization system that may function well for a consumer at one point in time may gradually become ill suited for the consumer's needs at a subsequent time. In order to adapt to their changing needs, consumers often discard and replace old organization systems with new, more suitable systems. In this manner, as the needs of a consumer continue to evolve, a cycle of implementing and replacing organization systems often occurs. This cycle, which may seem to be never ending, can leave a consumer frustrated and distraught with attempts to organize the typically increasing inventory of belongings according to the consumer's evolving use of such belongings.

### SUMMARY OF THE INVENTION

One aspect of the present invention relates to a storage shell including a plurality of sidewalls collectively defining a chamber therebetween. A first sidewall defines a panel and a track. The panel defines an outer perimeter edge, an exterior surface, and holes extending through the panel. The track is coupled to the panel and includes a first rib and a second rib each extending from the exterior surface. The first rib is positioned inside the outer perimeter edge. The second rib is concentric with and shaped similarly to the first rib. The first rib and the second rib each separately border each one of the holes where each of the holes is formed between the first rib and the second rib. Related products, systems, components and methods are also disclosed and provide additional advantages.

### BRIEF DESCRIPTION OF THE DRAWINGS

Embodiments of the invention will be described with respect to the figures, in which like reference numerals denote like elements, and in which:

FIG. 1 illustrates a perspective view of a storage shell, according to one embodiment of the present invention.

FIG. 2 illustrates a front view of the storage shell of FIG. 1, according to one embodiment of the present invention.

FIG. 3 illustrates a rear view of the storage shell of FIG. 1, according to one embodiment of the present invention.

FIG. 4 illustrates a top view of the storage shell of FIG. 1, according to one embodiment of the present invention.

FIG. 5 illustrates a bottom view of the storage shell of FIG. 1, according to one embodiment of the present invention.

FIG. 6 illustrates a right side view of the storage shell of FIG. 1, according to one embodiment of the present invention.

FIG. 7 illustrates a left side view of the storage shell of FIG. 1, according to one embodiment of the present invention.

FIG. 8 illustrates a detail view of a portion of the storage shell as indicated in FIG. 1, according to one embodiment of the present invention.

FIG. 9 illustrates a storage and organization system including the storage shell of FIG. 1, according to one embodiment of the present invention.

FIG. 10 illustrates a cross-sectional view as indicated by the line X-X in FIG. 9, according to one embodiment of the present invention.

FIG. 11 illustrates a bottom perspective view of a tray for use with the storage shell of FIG. 1, according to one embodiment of the present invention.

FIG. 12 illustrates a top portion of a storage shell with a portion of the tray of FIG. 11 illustrated in dashed lines, according to one embodiment of the present invention.

FIG. 13 illustrates a support base for use with the storage shell of FIG. 1, according to one embodiment of the present invention.

FIG. 14 illustrates the support shell of FIG. 1 with drawer and drawer support accessories, according to one embodiment of the present invention.

FIG. 15 illustrates a flow chart for a method of assembling a storage and organization system, according to one embodiment of the present invention.

FIG. 16 illustrates a flow chart for a method of providing a storage and organization system, according to one embodiment of the present invention.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A storage and organization system according to the embodiments described herein is configured to store a plurality of goods, such as a consumer's belongings, and to be easily reconfigured to evolve with the changing needs of the consumer. In one example, the system described herein is configured to be assembled without permanency while still providing a sturdy and aesthetically pleasing storage assembly. In one embodiment, although the general components of the system are configured for a plurality of purposes, additional accessory and other components are provided and configured to interface with the general components to personalize the system for use in a particular area of the home, at a particular time in a consumer's life, etc., based on the needs of the consumer. As such, in one example, the storage and organization system is an adaptable, aesthetically pleasing alternative to the plurality of mismatched organizational units generally available in the prior art.

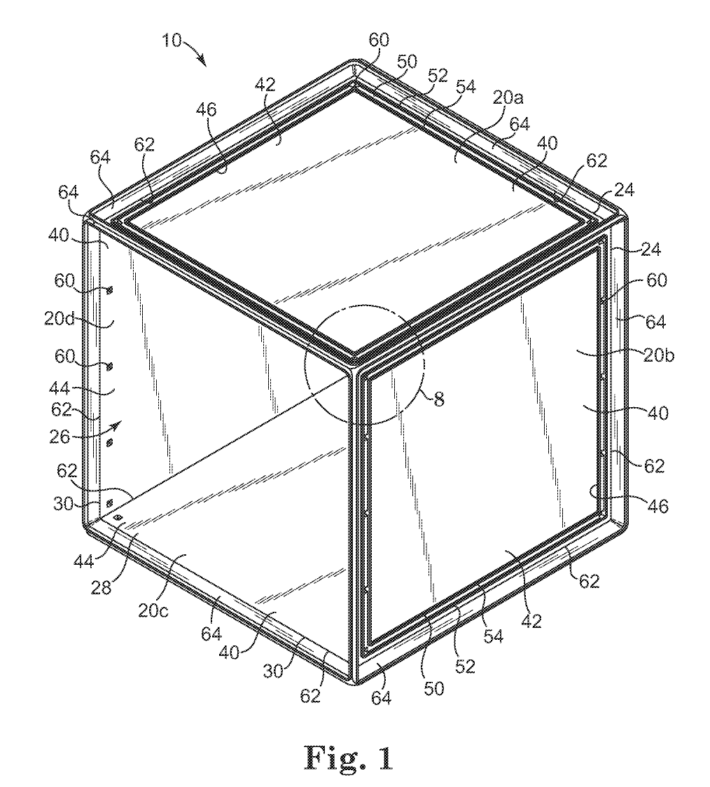

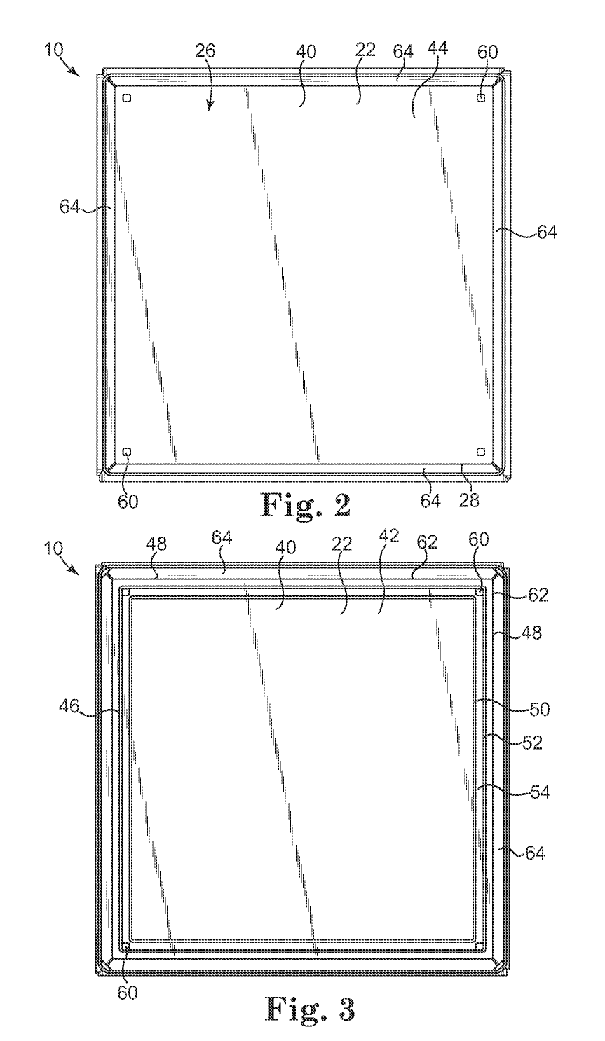

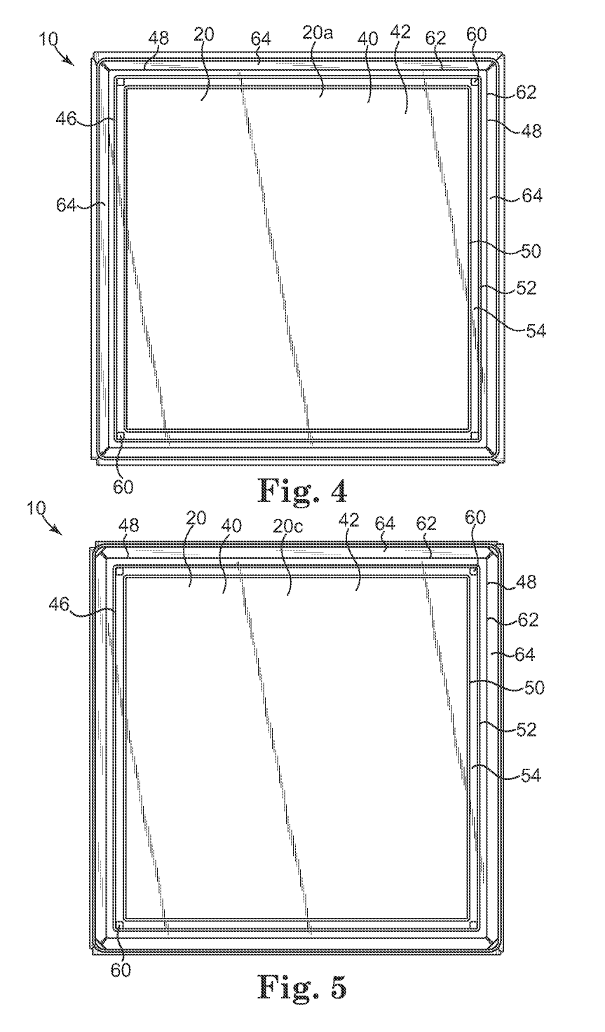

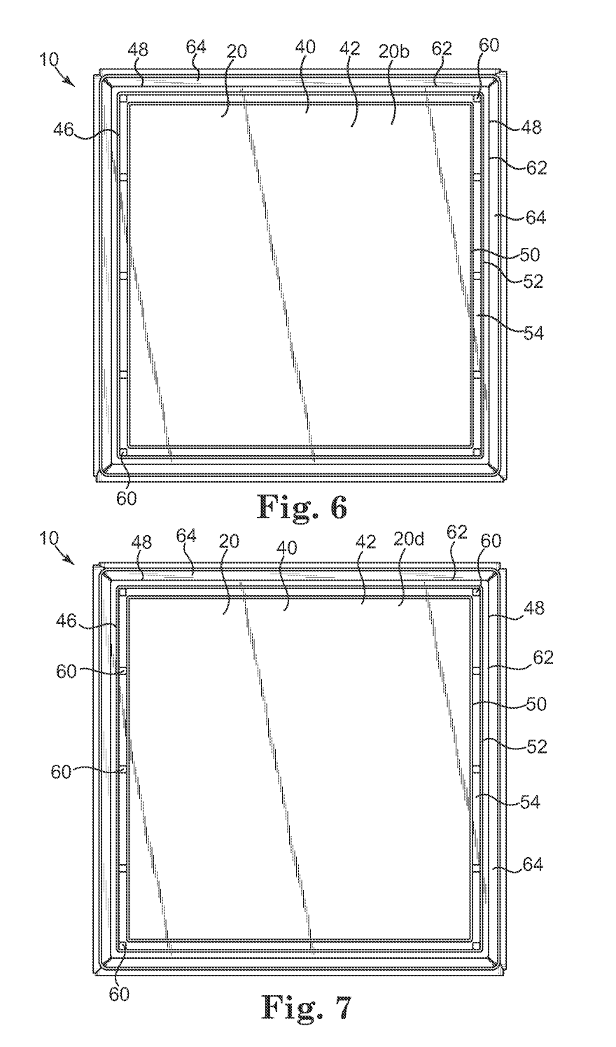

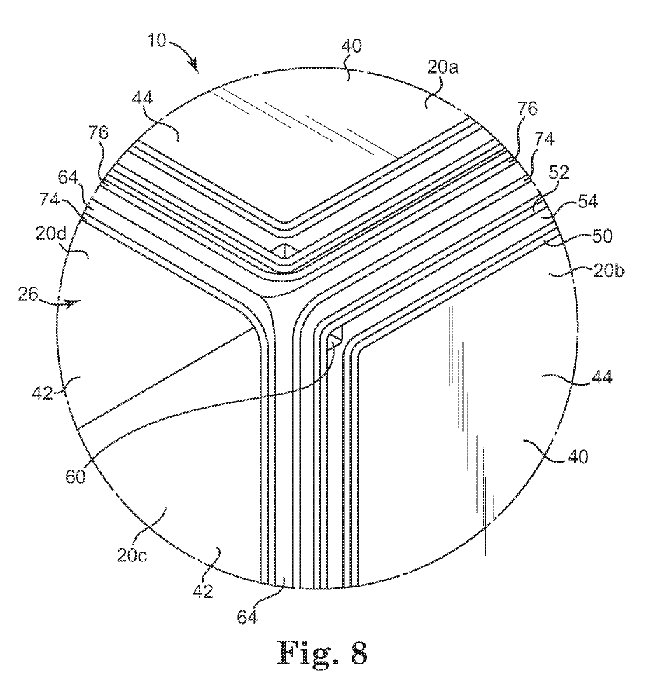

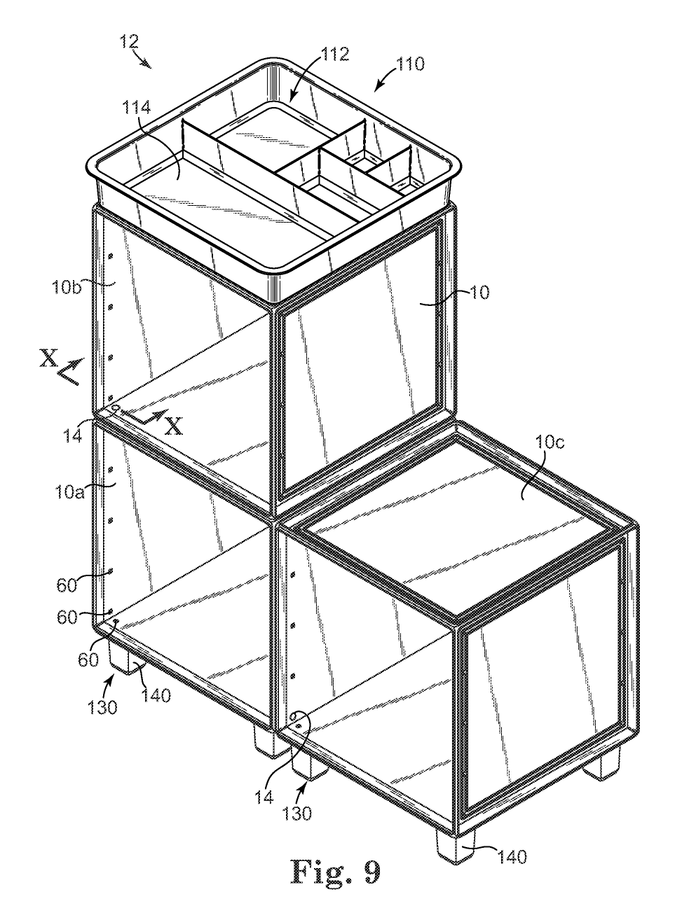

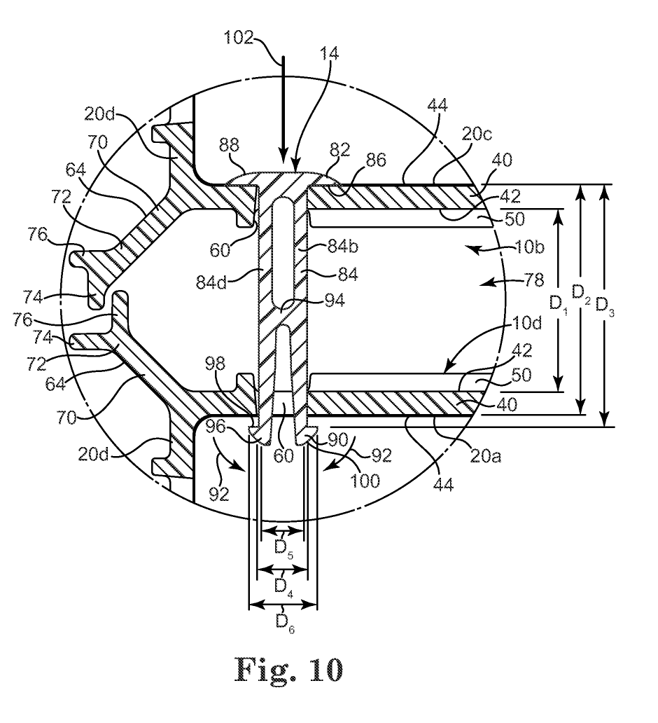

Turning to the figures, FIGS. 1-8 each generally illustrate storage shell 10 (e.g., a storage box) or at least a portion thereof according to one embodiment of the present invention. Storage shell 10 serves as a basic building block of a storage and organization system 12 (for example, as illustrated in FIG. 9). Storage shells 10 are configured to be substantially modular and readily couplable and repositionable relative to one another without causing damage to any storage shell 10. In one embodiment, storage shells 10 are configured to be selectively coupled to one another using repositionable and reversible clips 14 (e.g., as illustrated in FIGS. 9 and 10), which will be further described below.

In one embodiment, each storage shell 10 defines four sidewalls 20a, 20b, 20c, and 20d (collectively referred to as sidewalls 20) and a rear wall 22. Each sidewall 20 is substantially rectangular (e.g., square) and extends between opposite edges of two other sidewalls 20 to define a rectangular box-like structure. Rear wall 22 is coupled to a rear edge 24 of each sidewall 20 such that a compartment 26 (e.g., a cavity, chamber, or void) is defined by storage shell 10 between sidewalls 20 and rear wall 22. A front opening 28 to compartment 26 is defined opposite rear wall 22 and is bordered by a front edge 30 of each of the sidewalls 20 opposite rear edges 24. As such, in one embodiment, storage shell 10 is essentially formed as a parallelepiped with an open face (i.e., front opening 28) opposite rear wall 22. In one embodiment, each storage shell 10 is formed from a single material, for example, a suitable plastic material or similar material injection or otherwise molded to form storage shell 10.

Referring to FIG. 1, in one embodiment, each sidewall 20 includes a substantially planar panel 40 in a square or other rectangular shape defining an exterior surface 42 and an interior surface 44 opposite exterior surface 42. In one example, a separate track 46 extends outwardly (i.e., away from compartment 26) from exterior surface 42 of each substantially planar panel 40. Track 46, more specifically, extends around exterior surface 42 inset slightly from outer perimeter edges 48 of the corresponding substantially planar panel 40. As such, an outer perimeter of track 46 is shaped similarly to, but is slightly smaller than, an outer perimeter of a corresponding substantially planar panel 40.

In one example, track 46 includes a first or inner rib 50 and a second or outer rib 52. Inner rib 50 is positioned just inside and is concentric with outer rib 52. In one embodiment, inner rib 50 and outer rib 52 are each continuous and define four linear lengths in a generally square or otherwise rectangular manner. Track 46 defines an opening or groove 54 between inner rib 50 and outer rib 52. In one example, each of inner rib 50 and outer rib 52 and track 46 as a whole, provide additional rigidity and support to sidewalls 20. For instance, track 46 provides each substantially planar panel 40 with additional strength and decreases twisting, warping, or other deformations of substantially planar panel 40 when storage shell 10 is loaded with goods, etc. In one embodiment, use of track 46 allows substantially planar panel 40 to be formed thinner than if no track 46 were used as will be apparent to those of skill in the art upon reading the present application. Use of thinner walls decreases the amount of material needed to form each storage shell 10 and thereby reduces the cost of manufacturing the resultant storage shells 10.

In one example, one or more apertures or holes 60 extend through each sidewall 20, for example, in groove 54 of track 46. In one embodiment, each hole 60 is substantially square or otherwise rectangular in shape. In one embodiment, a hole 60 is defined in each of the four corners of track 46 in each of the four sidewalls 20 and rear wall 22. Additional holes 60 may be defined along one or more linear lengths of track 46. In one example, some sidewalls 20 include similar numbers and positioning of holes 60 while other sidewalls 20 and/or rear wall 22 may have different numbers and/or arrangements of holes 60. For example, top and bottom sidewalls 20a and 20c, which are positioned opposite and parallel to one another, only have holes 60 in the corners of the corresponding tracks 46. Vertical sidewalls 20b and 20d, which are positioned opposite and parallel to one another and perpendicular to top and bottom sidewalls 20a and 20c, include holes 60 in the corners of the corresponding tracks 46 and additionally each include a plurality of holes 60 linearly spaced at equal distances from one other along at least two of the linear lengths of each track 46. For example, vertical sidewalls 20b and 20d each have a plurality of holes 60 defined in portions of the groove 54 defined along the front and rear lengths (i.e., the vertical lengths) of the corresponding tracks 46.

An intersection line 62 is defined at the border between any one sidewall 20, rear wall 22, or front opening 28 and another sidewall 20, rear wall 22, or front opening 30. Accordingly, in one embodiment, twelve intersection lines 62 are formed by storage shell 10 including four around front opening 30, four around rear wall 22, and four extending front to back and being defined at the boundary between adjacent sidewalls 20. Additionally referring to the cross-sectional view of FIG. 10, in one embodiment, a flange 64 extends radially outwardly from one or more of the intersection lines 62, for example, from each intersection line 62, in a plane angled with respect to adjacent ones of sidewalls 20, rear wall 22, and front opening 30. As used herein, “radially” refers to a divergent extension of a member relative to a center of a corresponding storage shell 10 unless another reference is specifically provided. In one embodiment, each flange 64 radially extends from intersection line 62 at an angle between about 30° and about 60° as measured from each adjacent sidewall 20, rear wall 22, or front opening 30, for example, at an angle of about 45°.

In one embodiment, each flange 64 is substantially Y-shaped and includes a primary leg 70 extending from the corresponding intersection line 62 to define an outer end 72 opposite the corresponding intersection line 62. In one example, flange 64 additionally includes first and second auxiliary legs 74 and 76 extending substantially perpendicular to one another. In one embodiment, each of first and second auxiliary legs 74 and 76 extends from outer end 72 of primary leg 70 at an angle of between about 30° and about 60° from primary leg 70, for example, at an angle of about 45°. In one example, first and second auxiliary legs 74 and 76 each extend substantially parallel to at least one of sidewalls 20 and rear wall 22.

Referring to FIG. 9, multiple storage shells 10 are configured to be stacked and arranged to define a storage and organization system 12 in a modular manner. To facilitate a user in configuring the multiple storage shells 10, storage shells 10 are configured to be easily secured to one another without the use of tools other than connection clips 14 (e.g., connection devices). For example, two storage shells 10 may be stacked such that a bottom or first storage shell 10a supports a top or second storage shell 10b.

When shells 10 are stacked, two or more (e.g., all four) of flanges 64 adjacent top sidewall 20a of first storage shell 10a interact with two or more (e.g., all four) of flanges 64 adjacent bottom sidewall 20c of second storage shell 10b, for example, as illustrated in the cross-sectional view of FIG. 10. In one example, when the above-described flanges 64 interact, second auxiliary legs 76 of flanges 64 adjacent top sidewall 20a of first storage shell 10a are positioned adjacent and nest with first auxiliary legs 74 of flanges 64 adjacent bottom sidewall 20c. This nesting substantially maintains second storage shell 10b in place relative to first storage shell 10a, more particularly in place from side to side and from front to back of storage shells 10. For example, second auxiliary legs 76 of flanges 64 adjacent top sidewall 20a of first storage shell 10a extend just inside first auxiliary legs 74 of flanges 64 adjacent bottom sidewall 20c. In one embodiment, the opposite configuration of second auxiliary legs 76 of flanges 64 adjacent top sidewall 20a of first storage shell 10a and first auxiliary legs 74 of flanges 64 adjacent bottom sidewall 20c may be used as will be apparent to those of skill in the art upon reading this application.

Interaction between flanges 64 maintains top sidewall 20a of first storage shell 10a spaced from and positioned substantially parallel to bottom sidewall 20c of second storage shell 10b. For example, first auxiliary legs 74 of flanges 64 adjacent bottom sidewall 20c of second storage shell 10b rests on first auxiliary legs 74 of flanges 64 adjacent top sidewall 20a of first storage shell 10a. The above-described flange 64 interactions maintain top sidewall 20a of first storage shell 10a spaced from bottom sidewall 20c of second storage shell 10b. Notably, first auxiliary leg 74 of flanges 64 adjacent bottom sidewall 20c of second storage shell 10b are shown slightly spaced from first auxiliary leg 74 of flanges 64 adjacent top sidewall 20a of first storage shell 10a, in FIG. 10 for clarity of illustration as will be apparent to those of skill in the art upon reading the present application. When stacked, a cavity 78 is defined between bottom sidewall 20c of second storage shell 10b and top sidewall 20a of first storage shell 10a.

More specifically, a first distance D₁ (i.e., thickness of cavity 78) is defined between exterior surface 42 of bottom sidewall 20c of second storage shell 10b and exterior surface 42 of top sidewall 20a of first storage shell 10a. In one embodiment, distance D₁ is substantially larger than a total thickness of each sidewall 20 defined between the respective interior surface 44 and exterior surface 42 thereof. In one example, distance D₁ is at least four times larger than a total thickness of any one of sidewalls 20. A second distance D₂ is defined between interior surface 44 of bottom sidewall 20c of second storage shell 10b and interior surface 44 of top sidewall 20a of first storage shell 10a.

When first storage shell 10a and second storage shell 10b are stacked, holes 60 extending through top sidewall 20a of first storage shell 10a and holes 60 extending through bottom sidewall 20b of second storage shell 10b align with one another (e.g., from front to back and from left to right). As illustrated in FIGS. 9 and 10, clips 14 are used to secure adjacent storage shells 10 to one another. Each clip 14 includes a head 82 and two symmetrical legs 84 (i.e., first leg 84a and second leg 84b or, collectively, a pair of legs). Head 82 defines a substantially planar surface 86 having a larger outer perimeter than holes 60 and may be formed circular, square, or any other suitable shape. In one example, a surface 88 of head 82 opposite substantially planar surface 86 is substantially flat; however, surface 88 may be rounded or otherwise shaped.

Each of legs 84 extends from substantially planar surface 86 of head 82 to a free end 90. In one example, each leg 84 is elongated (e.g., substantially rectangular) and spaced from the other leg 84. More specifically, in one embodiment, outer and opposite surfaces of legs 84 are spaced from each other a distance less than an interior diameter (i.e., interior width) of holes 60 such that legs 84 are configured to fit through holes 60 in storage shells 10. In one example, legs 84 are formed of a slightly flexible and elastomeric material allowing legs 84 to flex in toward one another as generally indicated by arrows 92 in FIG. 10 when inward forces are applied thereto and to elastically return to their initial position when the inward forces are removed. In one embodiment, to limit the flexing of legs 84 toward one another, a bridge member 94 extends substantially perpendicular to and between legs 84. Bridge member 94 extends from legs 84 at points along a middle third of the length of legs 84, for example, substantially half way between substantially planar surface 86 and free ends 90. With bridge member 94 in place, flexing of legs 84 is primarily limited to a portion of each leg 84 extending between bridge member 94 and the corresponding free end 90.

In one example, a protrusion or claw 96 is defined near each free end 90. More specifically, one claw 96 extends from free end 90 of first leg 84a away from second leg 84b, and one claw 96 extends from free end 90 of second leg 84b away from first leg 84a. As such, claws 96 extend radially outwardly (i.e., away from one another) from each leg 84. In one embodiment, each claw 96 defines an interface surface 98, which, in one example, is substantially planar, on a portion of each claw 96 nearest and facing substantially planar surface 86 of head 82. In one embodiment, interface surfaces 98 extend substantially parallel to substantially planar surface 86. In one example, a distance D₂ is defined between interior surface 44 of bottom sidewall 20c of second storage shell 10b and interior surface 44 of top sidewall 20a of first storage shell 10a. A distance D₃ is defined between substantially planar surface 86 and interface surface 98 and is slightly larger than distance D₂ (the difference between the two distances being slightly exaggerated in FIG. 10 for illustrative clarity as will be apparent to those of skill in the art upon reading this application).

In one embodiment, claw 96 defines an angled surface 100 from a tip of free end 90 toward an outwardly most portion of interface surface 98. As such, angled surface 100 extends radially outwardly and toward head 82. At their closest points, angled surface 100 of first leg 84a and angled surface 100 of second leg 84b are spaced from one another a distance D₅, which is less that a diameter or width D₄ of holes 60. At their furthest spaced points, angled surface 100 of first leg 84a and angled surface 100 of second leg 84b are spaced from one another a distance D₆, which is greater than a diameter or width D₄ of holes 60. In one embodiment, each clip 14 is formed as a contiguous piece of a single material, for example, injection molded plastic.

When used to secure two storage shells 10 such as first storage shell 10a and second storage shell 10b to one another, clip 14 is pushed through holes 60 of both storage shells 10a and 10b. For example, as shown in FIGS. 9 and 10, clip 14 is pushed from interior surface 44 of bottom sidewall 20c of second storage shell 10b through a corresponding hole 60 formed therein and through a corresponding (i.e., aligned) hole 60 of top sidewall 20a of first storage shell 10a. More specifically, as clip 14 is pushed into hole 60 of bottom sidewall 20c of second storage shell 10b in the direction generally indicated by arrow 102, interior surface 44 of that bottom sidewall 20c interacts with angled surfaces 100 of clip 14 causing legs 84 of clip 14 to flex toward one another as generally indicated in FIG. 10 by arrows 92. Such flexing of legs 84 allows claw 96 of clip 14 to move through the hole 60 of bottom sidewall 20c of second storage shell 10b.

Once claw 96 clears hole 60 and track 46 of second storage shell 10b, legs 84 flex back to their initial position due to the elastomeric nature of the material used to form clip 14. When clip 14 is continued to move toward first storage shell 10a along the direction generally indicated by arrow 102, angled surfaces 100 of clip 14 to interact with track 46 of top sidewall 20a of first storage shell 10a again causing legs 84 of clip 14 to flex toward one another. Such flexing of legs 84 allows claw 96 of clip 14 to move through the top sidewall 20a of first storage shell 10a. Once claw 96 clears hole 60 of first storage shell 10a, legs 84 flex back to their initial position and claws 96 are positioned adjacent and substantially parallel to interior surface 44. In this position, clip 14 effectively holds first and second storage shells 10a and 10b together as claw 96 generally prevents clip 14 from moving back through top sidewall 20a of first storage shell 10a toward second storage shell 10b without purposeful user intervention with clip 14. In one embodiment, a clip 14 is similarly positioned between first storage shell 10a and second storage shell 10b through each of the corners holes 60 of bottom sidewall 20c of second storage shell 10b and top sidewall 20a of first storage shell 10a.

In one embodiment, when storage shells 10a and 10b are coupled to one another, top sidewall 20a of first storage shell 10a and bottom sidewall 20c of second storage shell 10c are maintained entirely spaced from one another even between corresponding tracks 46 of storage shells 10a and 10b. In other words, storage shells 10a and 10b only contact each other at free ends of flanges 64, for example, at auxiliary legs 74, 76. As such, a length of clip 14 independently extends between top sidewall 20a of first storage shell 10a and bottom sidewall 20c of second storage shell 10c entirely unsupported or bordered by any sidewall 20 or other portion of storage shells 10a and 10b. In one embodiment, the distance of clip 14 that is unsupported is over half the length of clip 14.

When clips 14 are so positioned coupling storage shells 10a and 10b to one another, tracks 46 provide additional structural stability to storage and organization system 12. Since holes 60 are positioned within grooves 54 defined by each track 46, at least two sides of holes 60 are reinforced by the corresponding adjacent ribs 50 and 52 of track 46, which, prevents or at least decreases any damage to adjacent sidewalls 20 that is caused by clips 14, for example, when clips 14 exert force on sidewalls 20 while holding adjacent storage shells 10 together. In addition, tracks 46 provide extra rigidity to individual sidewalls 20 allowing the sidewalls 20 to maintain their general shape and configuration even when supporting items for storage or use. In this manner, tracks 46 allow thinner sidewalls 20 to be made that still have sufficient rigidity to support any items placed in or on shells 10 for storage, which is of increased importance since sidewalls 20 of adjacent storage shells 10 do not contact or otherwise sit upon or support one another since only flanges 64 of adjacent storage shells 10 directly interact.

Additional storage shells 10 may be similarly coupled to one another using clips 14. Similarly, storage shells 10 may be secured side to side with clips 14 as generally indicated in FIG. 9 with first storage shell 10a and third storage shell 10c. Clips 14 also allow coupled storage shells 10 to be uncoupled from one another and reconfigured without the use of additional tools. For example, once again referring to FIG. 10, a user may apply a force as indicated by arrows 92 to free ends 90 of clip legs 84 causing free ends 90 to flex inward and to fit within the confines of holes 60. More specifically, while free ends 90 are flexed inward, a user pushes clip 14 toward second storage shell 10b causing free ends 90 to move through hole 60 within and through top sidewall 20a of first storage shell 10a. As such, first storage shell 10a is separated from second storage shell 10b. Clip 14 can similarly be flexed and moved back through bottom sidewall 20 of second storage shell 10b to separate clip 14 from second storage shell 10b.

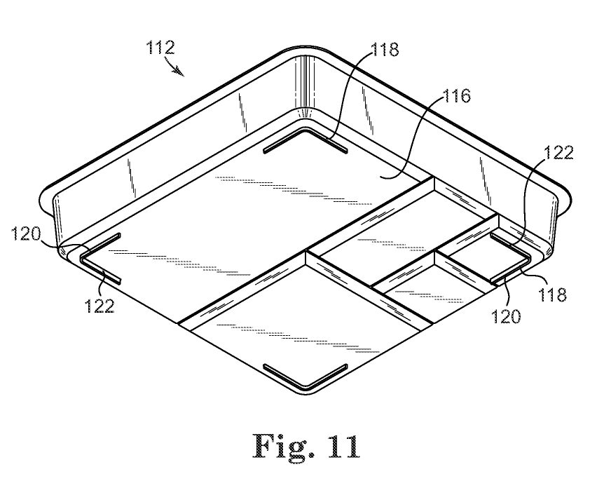

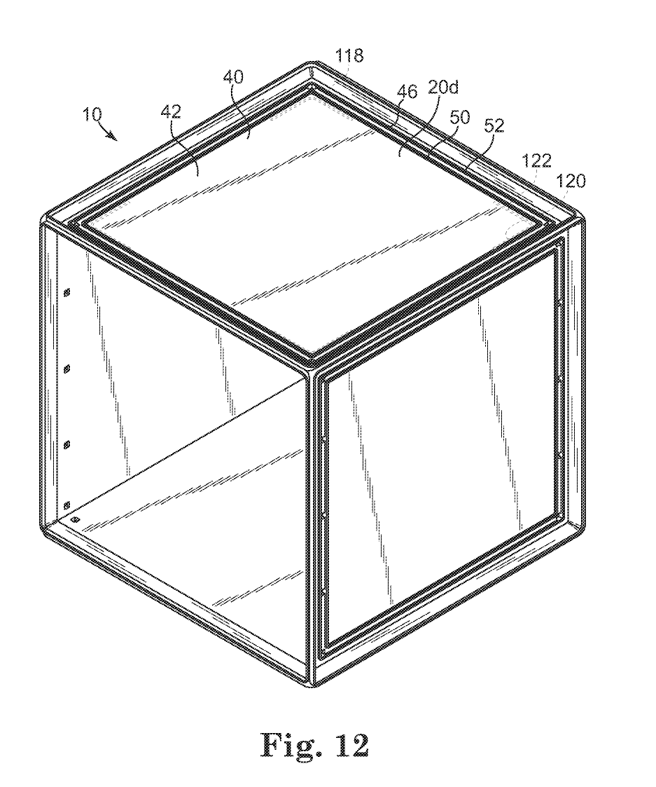

Besides facilitating coupling of storage shells 10 to one another, tracks 46 and holes 60 also facilitate coupling of accessory members 110 with storage shells 10. For example, referring to FIGS. 9 and 11, in one embodiment, accessory members 110 of storage and organization system 12 include a box or tray 112 defining one or more cavities 114 for storing or otherwise holding items. Tray 112 includes a bottom wall 116, which is substantially planar and may or may not be continuous. Ribs 118 extend downwardly from bottom wall 116, which, in one example, is substantially square or rectangular, near an outer perimeter thereof. In one example, a separate rib 118 is placed in each corner of bottom wall 116 and is generally L-shaped such that one leg 120 extends substantially perpendicular to another leg 122 of each rib 118. In one embodiment, ribs 118 are connected to one another to collectively define a closed-looped rib.

Ribs 118 are placed such that each leg 120 and 122 extends just inside an outer corner of bottom wall 116 and extends substantially parallel to a side edge of bottom wall 116. When tray 112 is placed on a top sidewall 20a of a storage shell 10, such as second storage shell 10b, at least one rib 118 is configured to fit within a corner of inner rib 50 of track 46. Where tray 112 is sized to cover substantially all of a top sidewall 20a, each rib 118 of tray 112 is configured to fit just inside a different corner of track 46. This interaction generally prevents or at least decreases side-to-side and/or front-to-back movement, especially, inadvertent movement, of tray 112 relative to top sidewall 20a of the respective storage shell 10.

As will be apparent to those of skill in the art upon reading this application, trays (not shown) sized differently than tray 112 may be used. For instance, two side-by-side trays may fit on top sidewall 20a of a storage shell 10 such that each tray has two ribs that interact with corners of track 46. For example, a first tray has two ribs where each rib interacts with the right side corners of track 46, and a second tray has two opposite ribs that each interact with the left side corners of track 46. Use of other numbers of trays configured to fit within track 46 of a single sidewall 20 is also contemplated.

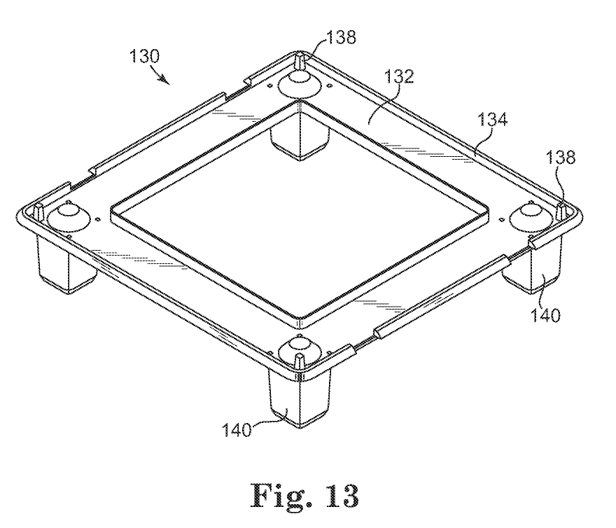

Referring to FIGS. 9 and 13, in one embodiment, accessory member(s) 100 include a support base 130. Support base 130 generally includes a substantially planar, primary panel 132 with raised edge 134 extending upwardly and around a perimeter thereof. Protruding pillars 138 also extend from primary panel 132, and each pillar 138 is positioned near and inset from a different corner of primary panel 132. Pillars 138 each extend away from primary panel 132 a distance greater than, for example, at least twice as far as, raised edge 134.

Legs 140 extend from corners of support base 130 in an opposite direction as raised edge 134 to provide height to base 130. Legs 140 may be static risers as illustrated in FIG. 13 or alternatively may incorporate casters or other support members as will be apparent to those of skill in the art upon reading this application.

Support base 130 is configured to interface with bottom sidewall 20c of a storage shell 10, for example, first storage shell 10a as illustrated in FIG. 9. More specifically, in one embodiment, each hole 60 in bottom sidewall 20c is sized, shaped, and positioned to receive a different one of pillars 138. In one embodiment, each pillar 138 is slightly tapered as it extends away from primary panel 132 such that as each pillar 138 is slid into a corresponding hole 60 it becomes tighter within hole 60 and is eventually held in place via friction fit. In one embodiment, raised edge 134 extends from primary panel 132 a similar distance as ribs 50 and 52 extend from substantially planar panels 40 of sidewalls 20. In one example, when support base 130 is coupled with a storage shell 10, raised edge 134 of support base 130 fits around outer rib 52 of track 46. As such, support base 130 is selectively coupled with the corresponding storage shell 10 and holds storage shell 10 above the ground, floor, or other support surface (not shown). Support base 130 is removable from the corresponding storage shell 10 simply by applying a force to move support base 130 away from storage shell 10 of a sufficient magnitude to overcome the friction fit between pillars 138 of support base 130 and holes 60 of shell 10.

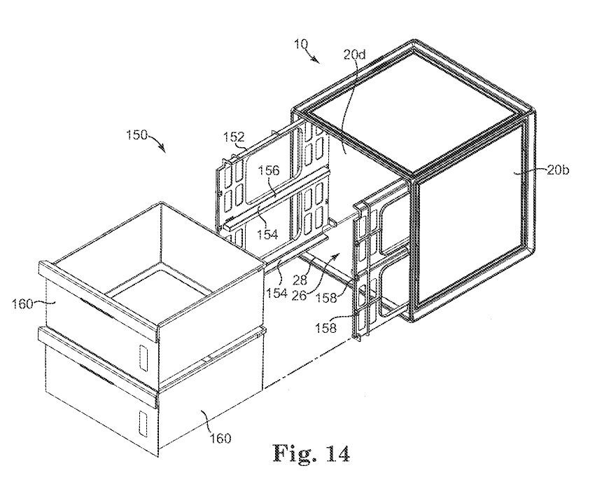

In one embodiment, accessory member(s) 100 also include interior members such as drawer unit 150 as illustrated in FIG. 14. Drawer unit 150 is configured to be inserted into compartment 26 of shell 12. In one embodiment, drawer unit 150 provides a pre-assembled and separately purchasable drawer sub-unit specifically configured to fit within a compartment 26 of shell storage 10. Drawer unit 150 is thereby configured to have similar, but slightly smaller, outside dimensions as compared to the inside dimensions of compartment 26 of storage shell 10. More specifically, drawer unit 150 includes vertical support walls 152 defining the outside dimensions of drawer unit 150. Support rails 154 extend inwardly from vertical support walls 152 and define a drawer support surface 156 on an upper portion thereof.

Connection tabs 158 extend from vertical support walls 152, and in one embodiment, are similar to, but not as long as, clip legs 84. Connection tabs 158 are sized, shaped, and positioned to selectively fit within holes 60 of vertical sidewalls 20b and 20d to selectively couple vertical support walls 152 with storage shell 10 within compartment 26. In one example, connection tabs 158 are only configured to interface with holes 60 of storage shell 10 that are not in respective corners of sidewalls 20 to avoid any conflict between clips 14 and connection tabs 158 (e.g., compare FIG. 9 with FIG. 14). In one embodiment, vertical support walls 152 are substantially eliminated and support rails 154 themselves include connection tabs 158 for selectively coupling support rails 154 to storage shell 10 as will be apparent to those of skill in the art upon reading the application.

Drawer unit 150 additionally includes one or more drawers 160 each configured to be selectively slid into and out of storage shell 10 upon assembly. More specifically, each drawer 160 is configured to be slidably supported on two opposite support rails (i.e., a support rail defined by each vertical support wall 152) such that drawers 160 can be repeatedly slid into and out of compartment 26.

Other accessory members 110, such as shelves, etc., are also contemplated as will be apparent to those of skill in the art upon reading this application and make use of holes 60 and/or track 46 to facilitate selective coupling with storage shells 10.

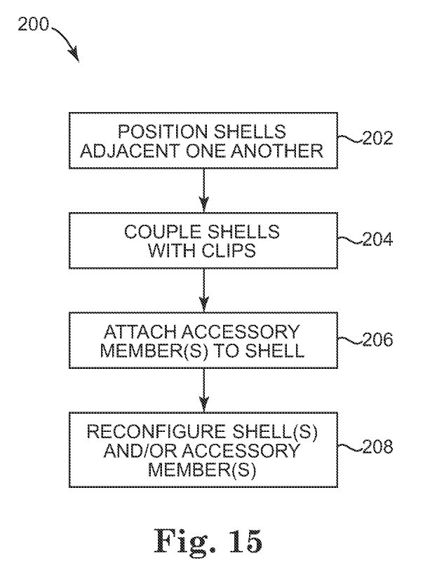

FIG. 15 is a flow chart generally illustrating one embodiment of a method 200 of using storage and organization system 12 as described with respect to FIGS. 1 and 9. At 202, two or more storage shells 10 are positioned adjacent one another. For example, storage shells 10 are stacked or otherwise positioned next to one another. Once storage shells 10 are configured as desired at 202, then at 204, storage shells 10 are coupled to one another with clips 14 as described above. For example, where two storage shells 10 are stacked, clips 14 are positioned to extend through bottom sidewall 20c of one storage shell 10 and through top sidewall 20a of the other storage shell 10. In one example, where two storage shells 10 are positioned side by side, clips 14 are positioned through a right sidewall 20b of one storage shell 10 and through a left sidewall 20d of the other storage shell 10.

At 206, accessory member(s) 110 if any, are added to storage and organization system 12. For example, tray 112 may be placed on a storage shell 10 such that ribs 118 of tray 112 interact with track 46, support base 130 may be coupled with a bottom sidewall 20c of a storage shell 10, drawer unit 150 may be positioned within compartment 26 and coupled with storage shell 10, and/or any other accessory member(s) 110 may be added to personalize and/or customize the storage and organizational system for a particular purpose or need of the user. If such user purposes or needs ever change, then at 208 the user may reconfigure storage shell(s) 10 and any accessory members 110 to repurpose the storage and organization system in view of the new or changing needs of the user. Operation 208 is facilitated by use of clips 14 and other attachments that are selective and easy to be removed without damaging individual components of the storage and organization system 12 and generally do not require the use of tools.

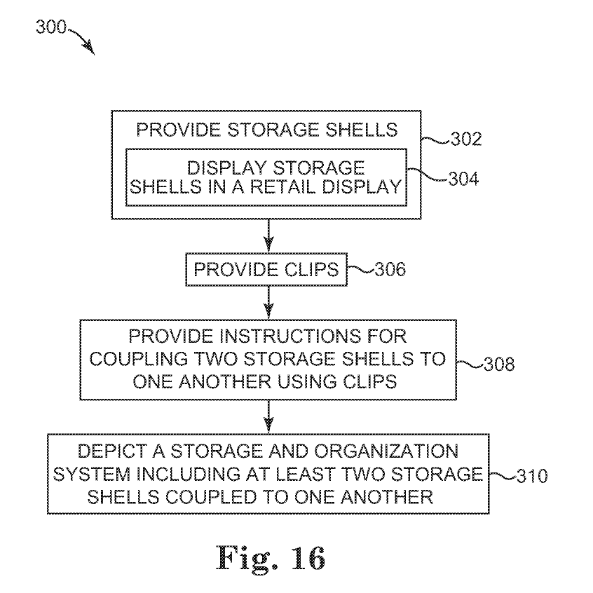

FIG. 16 illustrates one embodiment of a method 300 of providing a storage and organization system. For example, at 302, storage shells 10, for example, first storage shell 10a, second storage shell 10b, third storage shell 10c, etc., are provided. In one embodiment, providing storage shells 10 at 302 includes displaying storage shells 10 as part of a retail display viewable by potential consumers at 304. At 306, clips 14, and, in one example, other accessory members 110, are also provided and/or included as part of the retail display. At 308, instructions are provided to consumers instructing consumers regarding how to position and couple two or more storage shells 10 together using clips 308 and without using separate tools. For example, instructions indicate that two storage shells 10 should be placed adjacent to one another such that at least a portion of flanges 64 of each storage shell 10 interact with one another. Instructions further describe placing a clip 14 through a hole 60 in one storage shell 10 through an aligned hole 60 of another storage shell 10, etc. as described in greater detail above.

In one example, at 310, a storage and organization system, for example, storage and organization system 12 (FIG. 9), is depicted to consumers. The depiction provided at 310 not only serves as an example of how two or more storage shells 10 may be used together, but also provides inspiration to potential consumer regarding possible uses of storage shells 10. In one embodiment, by promoting different uses of storage shells 10, depiction promotes sale of storage shells 10 to consumers. In one example, the depiction provided at 310 is provided as part of or near the retail display providing storage shells 10.

It should be understood that “retail display” as used above generally refers to any tangible (e.g., in-store) or intangible (e.g., Internet-based) display of storage shells 10, etc. to potential consumers. Although method 300 is illustrated as a series of operations, in one embodiment, operations 302, 306, 308, and 310 can be performed in any order and/or two or more of operations 302, 306, 308, and 310 can be performed simultaneously as will be apparent to those of skill in the art upon reading this application.

Although the invention has been described to particular embodiments, such embodiments are for illustrative purposes only and should not be considered to limit the invention. Various alternatives and modifications within the scope of the invention in its various embodiments will be apparent to those with ordinary skill in the art upon reading this application.

What is claimed is:

1. A storage shell comprising:
a plurality of sidewalls each extending between two others of the plurality of sidewalls to collectively define a chamber therebetween, the plurality of sidewalls including a first sidewall defining:
a substantially planar panel defining an outer perimeter edge, an exterior surface, and a plurality of holes extending through the substantially planar panel and positioned near the outer perimeter edge, and
a track coupled to the substantially planar panel, the track comprising:
a first rib positioned just inside and spaced from the outer perimeter edge of the substantially planar panel, the first rib extending from the exterior surface in a first direction away from the chamber, and
a second rib concentric with and shaped similarly to the first rib and positioned further away from the outer perimeter edge than the first rib, the second rib extending from the exterior surface in the first direction away from the chamber,
wherein the first rib borders each one of the plurality of holes, and the second rib separately borders each one of the plurality of holes, wherein each of the plurality of holes is formed between the first rib and the second rib.

2. The storage shell of claim 1, wherein the first rib and the second rib are each shaped similarly to, but sized smaller than, the outer perimeter edge of the substantially planar panel.

3. The storage shell of claim 1, wherein the storage shell is formed as a single contiguous piece of material.

4. The storage shell of claim 1, where the first rib and the second rib are each closed-loop in shape.

5. The storage shell of claim 1, in combination with a clip defining a head and two opposing legs, wherein the two opposing legs are configured to flex toward one another to allow the two opposing legs to pass through one of the plurality of holes in the substantially planar panel, and wherein the two opposing legs only fit through the one of the plurality of holes when the two opposing legs are flexed toward one another.

6. The storage shell of claim 5, wherein the clip is configured to be locked in place relative to and subsequently removed from the substantially planar panel without use of separate tools.

7. The storage shell of claim 1, wherein each of the plurality of sidewalls is substantially similar to the first sidewall.

8. The storage shell of claim 1, wherein the plurality of sidewalls are all collectively formed as a single contiguous piece of material.

9. The storage shell of claim 1, further comprising flanges each radially extending away from an intersection line defined along the outer perimeter edge of the substantially planar panel, wherein each of the flanges extends from the first sidewall with an angle between about 30° and about 60°.

10. The storage shell of claim 9, wherein the storage shell is a first storage shell and is provided in combination with a second storage shell, the second storage shell is similar to the first storage shell and comprises:
a plurality of sidewalls including a first sidewall of the second storage shell, and
flanges of the second storage shell, wherein the first storage shell and the second storage shell are positioned adjacent one another such that the flanges of the first storage shell interface with the flanges of the second storage shell in a manner maintaining the first sidewall of the first storage shell spaced from and substantially parallel to the first sidewall of the second storage shell.

11. The combination of claim 10, further comprising:
a clip extending between the first sidewall of the first storage shell and the first sidewall of the second storage shell, the clip being substantially unsupported between the first sidewall of the first storage shell and the first sidewall of the second storage shell for at least half a length of the clip.

12. The combination of claim 11, wherein the clip comprises:
a head defining a substantially planar surface and an outer diameter, the outer diameter being larger than an outer dimension of one of the plurality of holes of the first storage shell;
a pair of legs extending from the substantially planar surface of the head to define free ends opposite the substantially planar surface, wherein the free ends are configured to flex toward one another into a flexed position when corresponding forces are applied to the free ends and to return to an original position upon removal of the corresponding forces, the free ends define two claws each extending outwardly from a different one of the free ends of the pair of legs, the two claws collectively being wider than the outer dimension of the one of the plurality of holes of the first storage shell when the clip is in the original position, and the two claws are collectively narrower than the outer dimension of the one of the plurality of holes when the clip is in the flexed position.

13. The storage shell of claim 1, in combination with a support base comprising:
a planar member,
support legs extending from one side of the planar member; and
pillars each extending from an opposite side of the planar member in an opposite direction as support legs, wherein each pillar fits within one of the plurality of holes defined by the first sidewall.

14. The combination of claim 13, wherein each of the pillars is tapered as it extends away from the planar member.

15. The storage shell of claim 1, in combination with a tray defining a substantially planar bottom panel and at least two rails extending downwardly from the substantially planar bottom panel, wherein each of the at least two rails is selectively positioned adjacent to and within a corner of the track when the tray is placed on the first sidewall.

16. A storage and organization system comprising:
a first box comprising:
four first side panels coupled to one another to collectively define a first compartment therebetween, wherein a first aperture is defined by each of the first side panels, and
first flanges each extending away from a first intersection line defined along an outside perimeter length of each of the first side panels;
a second box comprising:
four second side panels coupled to one another to collectively define a second compartment therebetween, wherein a second aperture is defined by each of the second side panels, and
second flanges each extending away from a second intersection line defined along an outside perimeter of each of the second side panels,
wherein first and second boxes are positioned adjacent one another such that two or more of the first flanges contact two or more of the second flanges, wherein one of the first side panels is adjacent each of two or more of the first flanges, and one of the second side panels is adjacent each of the two or more of the second flanges, the one of the first side panels is positioned spaced from and extends generally parallel to the one of the second side panels to define a cavity therebetween; and
a connecting device extending through the first aperture and the second aperture to couple the first box to the second box, wherein the connecting device independently extends through the cavity defined between the one of the first side panels and the one of the second side panels.

17. The storage and organization system of claim 16, wherein each of the first flanges radially extends outwardly away from a center of the first box, and each of the second flanges radially extends outwardly away from a center of the second box.

18. The storage and organization system of claim 16, wherein the first side panels each include a track defined by a pair of ribs shaped similarly to and slightly offset from an outside perimeter of first side panel.

19. The storage and organization system of claim 16, wherein the connecting device comprises:
a head having an outer dimension larger than the first aperture and defining a substantially planar surface;
a pair of legs extending away from the substantially planar surface of the head, the pair of legs extending spaced from and substantially parallel to one another and extending substantially perpendicularly relative the substantially planar surface of the head, wherein the pair of legs are configured to flex toward one another to allow the pair of legs to pass through the first aperture and the second aperture, and wherein the pair of legs only fit through the first aperture and the second aperture when the pair of legs are flexed toward one another.

20. The storage and organization system of claim 16, wherein one of the first side panels faces the second box, the one of the first side panels is substantially planar, defines a exterior surface, and the first aperture is one of a plurality of first apertures defined by and extending through the one of the first side panels and is positioned near an outside perimeter of the one of the first side panels, and the first box further comprises:
a track coupled to the one of the first side panels, the track comprising:
a first rib positioned just inside and spaced from the outside perimeter of the one of the first side panels, the first rib extending from the exterior surface in a first direction away from the first compartment, and
a second rib concentric with and shaped similarly to the first rib and positioned further away from the outside perimeter of the one of the first side panels than the first rib, the second rib extending from the exterior surface in the first direction away from the first compartment,
wherein the first rib borders each the plurality of first apertures defined by the one of the first side panels, and the second rib separately borders each of the plurality of first apertures, wherein each of the plurality of first apertures of the one of the first side panels is formed between the first rib and the second rib.

21. A method of providing a storage and organization system, the method comprising:
providing a first shell and a second shell each comprising four sidewalls collectively defining a chamber therebetween, wherein each of the sidewalls defines an exterior surface and a pair of concentric ribs extending outwardly from the exterior surface of a corresponding one of the sidewalls, the pair of concentric ribs is shaped similar to but smaller than an outer perimeter of the corresponding one of the sidewalls, and apertures are defined through each of the sidewalls between a corresponding pair of concentric ribs such that each rib of the corresponding pair of concentric ribs directly borders a different portion of each of the apertures;
providing a clip configured to extend through one of the apertures formed in one of the sidewalls of the first shell and through one of the apertures formed in one of the sidewalls of the second shell to selectively couple the first shell to the second shell, wherein the one of the sidewalls of the first shell and the one of the sidewalls of the second shell that the clip extends through are entirely spaced from one another; and
providing instructions for coupling the first shell to the second shell using only the clip and additional similar clips without use of tools.

22. The method of claim 21, providing an auxiliary member configured to be selectively coupled to the first shell via apertures defined by the first shell.

23. The method of claim 22, wherein the auxiliary member is coupled to the first shell such that the auxiliary member is positioned within the chamber of the first shell.

24. The method of claim 21, wherein providing the first shell and the second shell includes displaying the first shell and a second shell as part of a retail display including depicting at least one configuration of a storage and organization system using at least two shells representative of the first shell and the second shell.
